(19) United States
(12) Patent Application Publication
(10) Pub. No.: US 2010/0074602 A1
(43) Pub. Date: Mar. 25, 2010

(54) SYSTEM AND METHOD FOR IMPROVED HEATING OF FLUID

(76) Inventors: Cedric Israelsohn, Victoria (AU); Robert Cornelis Van Aken, Victoria (AU)

Correspondence Address: GREER, BURNS & CRAIN, 300 S WACKER DR, 25TH FLOOR, CHICAGO, IL, 60606, US

(21) Appl. No.: 12/532,821

(22) PCT Filed: Feb. 22, 2008
(86) PCT No.: PCT/AU08/00241

§ 371 Date: Sep. 23, 2009

(30) Foreign Application Priority Data
Mar. 26, 2007 (AU) 2007901601
Mar. 30, 2007 (AU) 2007901707

(51) Int. Cl. F24H 9/20; H05B 3/60; F24H 1/10; F24D 17/00

(52) U.S. Cl. 392/312; 392/314; 392/318

(57) ABSTRACT

An apparatus for heating fluid, includes a preheat reservoir having at least one pair of reservoir electrodes between which an electric current can be passed through fluid in the preheat reservoir, to heat fluid in the reservoir to a preheat temperature, the preheat temperature being less than a desired output fluid temperature of the apparatus; and an outflow temperature boost passage through which fluid from the preheat reservoir flows to an outlet of the apparatus, the outflow temperature boost passage having at least one pair of outflow electrodes between which an electric current can be passed through fluid in the outflow temperature boost passage, to heat fluid dynamically in the outflow temperature boost passage to the desired output fluid temperature.

### CROSS-REFERENCE TO RELATED APPLICATIONS

The present application claims priority from Australian Provisional Patent Application No 2007901601, Australian Provisional Patent Application No 2007901707 filed on 26 Mar. 2007, 30 Mar. 2007, the contents of which are incorporated herein by reference.

### FIELD OF THE INVENTION

The present invention relates to an apparatus, a system and method for the rapid heating of fluid and more particularly, to an apparatus, system and method for rapidly heating fluid using electrical energy.

### BACKGROUND TO THE INVENTION

Hot water systems of one form or another are installed in the vast majority of residential and business premises in developed countries. In some countries, the most common energy source for the heating of water is electricity.

Of course, as it is generally known, the generation of electricity by the burning of fossil fuels significantly contributes to pollution and global warming. For example, in 1996, the largest electricity consuming sector in the United States were residential households, which were responsible for 20% of all carbon emissions produced. Of the total carbon emissions from this electricity-consuming sector, 63% were directly attributable to the burning of fossil fuels used to generate electricity for that sector.

In developed nations, electricity is now considered a practical necessity for residential premises and with electricity consumption per household growing at approximately 1.5% per annum since 1990 the projected increase in electricity consumption for the residential sector has become a central issue in the debate regarding carbon stabilisation and meeting the goals of the Kyoto Protocol or similar.

From 1982 to 1996 the number of households in the United States increased at a rate of 1.4% per annum and residential electricity consumption increased at a rate of 2.6% per annum for the same period. Accordingly, the number of households in the United States is projected to increase by 1.1% per annum through to the year 2010 and residential electricity consumption is expected to increase at a rate of 1.6% per annum for the same period.

It was estimated in 1995 that approximately 40 million households worldwide used electric water heating systems. The most common form of electric hot water heating system involves a storage tank in which water is heated slowly over time to a predetermined temperature. The water in the storage tank is maintained at the predetermined temperature as water is drawn from the storage tank and replenished with cold inlet water. Generally, storage tanks include a submerged electrical resistance heating element connected to the mains electricity supply whose operation is controlled by a thermostat or temperature-monitoring device.

Electric hot water storage systems are generally considered to be energy inefficient as they operate on the principle of storing and heating water to a predetermined temperature greater than the temperature required for usage, even though the consumer may not require hot water until some future time. As thermal energy is lost from the hot water in the storage tank, further consumption of electrical energy may be required to reheat that water to the predetermined temperature. Ultimately, a consumer may not require hot water for some considerable period of time. However, during that time, some electric hot water storage systems continue to consume energy to heat the water in preparation for a consumer requiring hot water at any time.

Of course, rapid heating of water such that the water temperature reaches a predetermined level within a short period of time enables a system to avoid the inefficiencies that necessarily occur as a result of storing hot water. Rapid heating or “instant” hot water systems are currently available where both gas, such as natural gas or LPG (Liquefied Petroleum Gas) and electricity are used as the energy source. In the case of natural gas and LPG, these are fuel sources that are particularly well suited to the rapid heating of fluid as the ignition of these fuels can impart sufficient thermal energy transfer to fluid and raise the temperature of that fluid to a satisfactory level within a relatively short time under controlled conditions.

However, whilst it is possible to use natural gas fuel sources for the rapid heating of water, these sources are not always readily available. In contrast, an electricity supply is readily available to most households in developed nations.

There have been previous ineffective attempts to produce an electrical “instant” hot water system. These include the hot wire and the electromagnetic induction systems. The hot wire “instant” hot water system has been developed wherein a wire is typically located in a thermally and electrically non-conductive tube of a relatively small diameter, or can be embodied in a housing that ensures the water flows in close proximity to the heated resistance wire. In operation, water passes through the tube in contact with or in very close proximity to the wire, which is energised to thereby transfer thermal energy to the water in the tube. Control is generally affected by monitoring the output temperature of water from the tube and comparing it with a predetermined temperature setting. Dependent upon the monitored output temperature of the water, a voltage is applied to the wire until the temperature of the water reaches the desired predetermined temperature setting.

Whilst the hot wire type of system avoids the energy inefficiencies involved with the storage of hot water, it unfortunately suffers a number of other disadvantages. In particular, it is necessary to heat the wire to temperatures much greater than that of the surrounding water. This has the disadvantageous effect of causing the formation of crystals of dissolved salts normally present in varying concentrations in water such as calcium carbonate and calcium sulphate. Hot areas of the wire in direct contact with the water provide an excellent environment for the formation of these types of crystals which results in the wire becoming “caked” and thus reducing the efficiency of thermal transfer from the wire to the surrounding water. As the tube can be relatively small in diameter in such circumstances, the formation of crystals can also reduce the flow of water through the tube. In addition, because of the necessity to ensure that the water stays in close proximity to the heated wire, hot wire type systems require relatively high water pressures for effective operation and thus these systems are not effective for use in regions that have relatively low water pressure or frequent drops in water pressure that may occur during times of peak water usage.

The electromagnetic induction system functions like a transformer. In this case currents induced into a secondary winding of the transformer cause the secondary winding to heat up. The heat generated here is dissipated by circulating water through a water jacket that surrounds the secondary winding. The heated water is then passed out of the system for usage. Control is generally effected by monitoring the output temperature of water from the water jacket and comparing it with a predetermined temperature setting. Dependent upon the monitored output temperature of the water, voltage applied to the primary winding can be varied, which varies the electric currents induces in the secondary winding until the temperature of the water reaches the desired predetermined temperature setting.

Whilst this type of system avoids the energy inefficiencies involved with the storage of hot water, it also suffers a number of other disadvantages. In particular, it is necessary to heat the secondary winding to temperatures greater than that of the surrounding water. This has the same effect of causing the formation of crystals of dissolved salts as discussed above. As the gap between the secondary winding and the surrounding water jacket is generally relatively narrow, the formation of crystals can also reduce the flow of water through the jacket.

In addition, the magnetic fields developed and the high currents induced in the secondary winding may result in unacceptable levels of electrical or RF noise. This electrical or RF noise can be difficult to suppress or shield, and affects other electromagnetic susceptible devices within range of the electromagnetic fields.

The above considerations apply similarly to both hot water systems, in which the desired output water temperature is generally no greater than around 60 degrees

Celsius, and to boiling water dispensers, in which the desired output temperature is generally higher such as in or around the range of 90-95 degrees Celsius.

It is therefore desirable to provide apparatus for rapid heating of fluid, particularly water, using electrical energy and which obviates at least some of the disadvantages of other systems.

It is also desirable to provide an improved method for rapidly heating fluid, particularly water, using electrical energy which minimises power consumption.

It is also desirable to provide an improved system for heating fluid, particularly water, using electrical energy which provides relatively rapid heating suitable for domestic and/or commercial purposes.

It is also desirable to provide an improved apparatus and method for electric fluid heating which facilitates control of the output temperature whilst minimising formation of crystals of dissolved salts.

It is also desirable to provide an improved fluid heating system which uses mains power generally available in domestic and commercial buildings.

It is also desirable to provide an improved heating apparatus which can be manufactured in various capacities of fluid throughput.

It is also desirable to provide fluid heating apparatus which can be designed to operate with a variety of fluids or with water of varying hardness.

It is also desirable to provide fluid heating apparatus which can be installed in close proximity to the hot water outlet, thereby reducing the time delay of the arrival of hot water and thereby obviating unnecessary wastage of water.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect, the present invention provides an apparatus for heating fluid comprising:
a preheat reservoir having at least one pair of reservoir electrodes between which an electric current can be passed through fluid in the preheat reservoir, to heat fluid in the reservoir to a preheat temperature, the preheat temperature being less than a desired output fluid temperature of the apparatus; and
an outflow temperature boost passage through which fluid from the preheat reservoir flows to an outlet of the apparatus, the outflow temperature boost passage having at least one pair of outflow electrodes between which an electric current can be passed through fluid in the outflow temperature boost passage, to heat fluid dynamically in the outflow temperature boost passage to the desired output fluid temperature.

According to a second aspect, the present invention provides a method of heating fluid comprising:
passing an electric current between at least one pair of reservoir electrodes of a preheat reservoir through fluid in the preheat reservoir, to heat the fluid in the reservoir to a preheat temperature, the preheat temperature being less than a desired output fluid temperature; and
at times of fluid outflow through an outflow temperature boost passage, passing current between at least one pair of outflow electrodes through fluid in the outflow temperature boost passage, to heat fluid dynamically in the outflow temperature boost passage to the desired output fluid temperature.

Embodiments of the invention preferably comprise reservoir fluid temperature measuring means to measure the temperature of the fluid in the reservoir. The reservoir fluid temperature measuring means is preferably positioned proximal to an inlet of the outflow temperature boost passage. Additionally or alternatively, there may be provided output fluid temperature measuring means to measure an output fluid temperature. The output fluid temperature measuring means is preferably positioned proximal to an outlet of the outflow temperature boost passage.

The outflow temperature boost passage preferably comprises at least first and second electrode sets disposed along the outflow temperature boost passage, said first electrode set and said second electrode set each having at least one pair of electrodes between which an electric current is passed through the said fluid to heat the fluid during its passage along the outflow temperature boost passage.

Embodiments of the invention preferably further comprise fluid flow rate determining means to determine a fluid flow rate through the outflow temperature boost passage.

Embodiments of the present invention preferably further comprise electrical control means to supply and control electrical power to the electrodes of the outflow temperature boost passage, said control means having processing means to relate current flow and applied voltage in response to measured reservoir fluid temperature and measured output fluid temperature and fluid flow rate, to determine desired power input to the fluid from each electrode set to achieve a desired output fluid temperature.

In one embodiment, an intra passage temperature measuring means measures the temperature of the fluid between the first and second electrode sets of the outflow temperature boost passage, and the control means controls power to the first and second electrode sets in accordance with the measured temperatures and a desired temperature increase of the fluid across each respective electrode set.

In a preferred embodiment, the electrodes of each pair are spaced across the flow path so that voltage applied between the electrodes of each pair causes current to flow through the fluid across the flow path as the fluid passes along the outflow temperature boost passage.

In preferred embodiments of the invention, control of the electrical power being passed to the fluid is provided by a microcomputer controlled management system. The microcomputer controlled management system is preferably able to detect and accommodate changes in the specific conductance of the fluid itself due to the change in temperature of the fluid within the system itself, as well as variances in electrical conductivity of the incoming fluid. That is, in preferred embodiments of the present invention, the management system monitors and responds to an electrical conductivity, or specific conductance gradient between the input and output of elements of the heating system. In a fluid heating system in accordance with an embodiment of the present invention used for domestic water heating, fluctuations in incoming water electrical conductivity can also be caused by factors such as varying water temperatures and varying concentrations of dissolved chemicals and salts, and such variations should be managed as a matter of course. However, preferred embodiments of the present invention will also manage and respond to changes in the electrical conductivity of the fluid as it is heated both within the reservoir and within the outflow temperature boost passage, that is, the effective management of the specific conductance gradient.

Thus, embodiments of the invention may comprise applying a variable electrical voltage between the electrodes of each set to thereby pass electrical currents through the fluid between electrodes of each set; monitoring the currents passing through the fluid between electrodes of each electrode set in response to application of the variable electrical voltage; and controlling the variable electrical voltage between electrodes of each electrode set in response to the specific conductance of the fluid as determined by reference to the monitored fluid temperatures and current flows such that an amount of electrical power passed to the fluid by each electrode pair corresponds to a predetermined temperature increase of the fluid.

In preferred embodiments of the method of the present invention, additional further steps may be carried out comprising compensating for a change in the electrical conductivity of the fluid caused by varying temperatures and varying concentrations of dissolved chemicals and salts, and through the heating of the fluid, by altering the variable electrical voltage to accommodate for changes in specific conductance when increasing the fluid temperature by the desired amount. Such a step may be performed by controlling the electrical power applied to the electrode sets to maintain the required constant fluid temperature increase in that electrode segment. The variable electrical voltage may then be adjusted to compensate for changes in specific conductance of the fluid within the segment of the flow path associated with each electrode pair, which will affect the current drawn by the fluid in that segment. The changes in specific conductance of the fluid passing through the separate electrode segments can be managed separately in this manner. Therefore the system is able to effectively control and manage the resulting specific conductance gradient across the whole system.

The desired temperature of the outlet fluid may be adjusted by a user via an adjustable control means.

The volume of fluid passing between any set of electrodes may be accurately determined by measuring the dimensions of the passage within which the fluid is exposed to the electrodes taken in conjunction with fluid flow.

Similarly, the time for which a given volume of fluid will receive electrical power from the electrodes may be determined by measuring the flow rate of fluid through the outflow temperature boost passage. The temperature increase of the fluid is proportional to the amount of electrical power applied to the fluid. The amount of electrical power required to raise the temperature of the fluid a known amount, is proportional to the mass (volume) of the fluid being heated and the fluid flow rate through the passage. The measurement of electrical current flowing through the fluid can be used as a measure of the electrical conductivity, or the specific conductance of that fluid and hence allows determination of the required change in applied voltage required to keep the applied electrical power constant. The electrical conductivity, and hence the specific conductance of the fluid being heated will change with rising temperature, thus causing a specific conductance gradient along the path of fluid flow.

The energy required to increase the temperature of a body of fluid may be determined by combining two relationships:

Energy=Specific Heat Capacity×Density×Volume×Temp-Change Relationship (1)

or

The energy per unit of time required to increase the temperature of a body of fluid may be determined by the relationship:

$$Power ( P ) = \frac{\begin{matrix}Specific Heat Capacity ( S H C ) \times \\ Density \times Vol ( V ) \times Temp \text{-} Change ( Dt ) \end{matrix}}{Time ( T )}$$

For analysis purposes, the specific heat capacity of water may be considered as a constant between the temperatures of 0 deg C. and 100 deg C. The density of water being equal to 1, may also be considered constant. Therefore, the amount of energy required to change the temperature of a unit mass of water, 1 deg C. in 1 second is considered as a constant and can be labelled “k”. Volume/Time is the equivalent of flow rate (Fr). Thus the energy per unit of time required to increase the temperature of a body of fluid may be determined by the relationship:

$$Power ( P ) = \frac{k \times Flow rate ( F r ) \times Temp \text{-} Change ( Dt )}{Time ( T )}$$

Thus if the required temperature change is known, the flow rate can be determined and the power required can be calculated.

Typically, when a user requires heated water, a hot water tap is operated thus causing water to flow from the reservoir through the outflow temperature boost passage. This flow of water may be detected by a flow meter and cause the initiation of a heating sequence. The temperature of the reservoir water may be measured and compared with a preset desired temperature for water output from the system. From these two values, the required change in water temperature from inlet to outlet of the outflow temperature boost passage may be determined.

Of course, the temperature of the inlet water to the electrode segments may be repeatedly measured over time and as the value for the measured inlet water temperature changes, the calculated value for the required temperature change from inlet to outlet of the electrode segments can be adjusted accordingly. Similarly, with changing temperature, mineral content and the like, changes in electrical conductivity and therefore specific conductance of the fluid may occur over time. Accordingly, the current passing through the fluid will change causing the resulting power applied to the water to change. Repeatedly measuring the temperature outputs of the electrode segments over time and comparing these with the required output temperature values will enable repeated calculations to continually optimise the voltage applied to the electrode segments.

In one preferred embodiment, a computing means provided by the microcomputer controlled management system is used to determine the electrical power that should be applied to the fluid passing between the electrodes, by determining the value of electrical power that will effect the desired temperature change between the electrode segment inlet and outlet, measuring the effect of changes to the specific conductance of the water and thereby calculate the voltage that needs to be applied for a given flow rate.

Relationship (2) Control of Electrical Power

In preferred embodiments of the present invention, the electrical current flowing between the electrodes within each electrode segment, and hence through the fluid, is measured. The electrode segment input and output temperatures are also measured. Measurement of the electrical current and temperature allows the computing means of the microcomputer controlled management system to determine the power required to be applied to the fluid in an electrode segment to increase the temperature of the fluid by a desired amount.

In one embodiment, the computing means provided by the microcomputer controlled management system determines the electrical power that should be applied to the fluid passing between the electrodes and thereby calculate the average voltage that needs to be applied to keep the temperature change substantially constant.

Relationship (2) below, facilitates the calculation of the electrical power to be applied as accurately as possible, almost instantaneously. This eliminates the need for unnecessary water usage otherwise required to initially pass through the system before facilitating the delivery of water at the required temperature. This provides the potential for saving water or other fluid.

In the preferred embodiments, having determined the electrical power that should be supplied to the fluid passing between the electrodes, the computing means may then calculate the voltage that should be applied to each Electrode Segment (ES) as follows: if the Power required for the electrode segment can be calculated, and the current drawn by the electrode segment (n) can be measured:

Voltage ESₙ(Vₐₚₚₙ)=Power ESₙ(P_{reqn})/Current ESₙ(Iₛₙ) Vₐₚₚₙ=P_{reqn}/Iₛₙ Relationship (2)

As part of the initial heating sequence, the applied voltage may be set to a relatively low value in order to determine the initial specific conductance of the fluid passing between the electrodes. The application of voltage to the electrodes will cause current to be drawn through the fluid passing therebetween thus enabling determination of the specific conductance of the fluid, as it is directly proportional to the current drawn therethrough. Accordingly, having determined the electrical power that should be supplied to the fluid flowing between the electrodes in the electrode segments, it is possible to determine the required voltage that should be applied to those electrodes in order to increase the temperature of the fluid flowing between the electrodes in the electrode segments by the required amount. The instantaneous current being drawn by the fluid is preferably continually monitored for change along the length of the outflow temperature boost passage. Any change in instantaneous current drawn at any position along the passage is indicative of the change in electrical conductivity or specific conductance of the fluid. The varying values of specific conductance apparent in the fluid passing between the electrodes in the electrode segments, effectively defines the specific conductivity gradient along the heating path.

Preferably, various parameters are continuously monitored and calculations continuously performed to determine the electrical power that should be supplied to the fluid and the voltage that should be applied to the electrodes in order to raise the temperature of the fluid to a preset desired temperature in a given period.

### BRIEF DESCRIPTION OF THE DRAWINGS

Examples of the invention will now be described with reference to the accompanying drawings in which:

FIG. 1 is a side view of a fluid heating apparatus according to one embodiment of the present invention;

FIG. 2 is a schematic block diagram of a system incorporating the apparatus of FIG. 1;

FIG. 3 is a flowchart illustrating the operation of the system of FIG. 2.

### DETAILED DESCRIPTION OF THE PREFERRED EMBODIMENTS

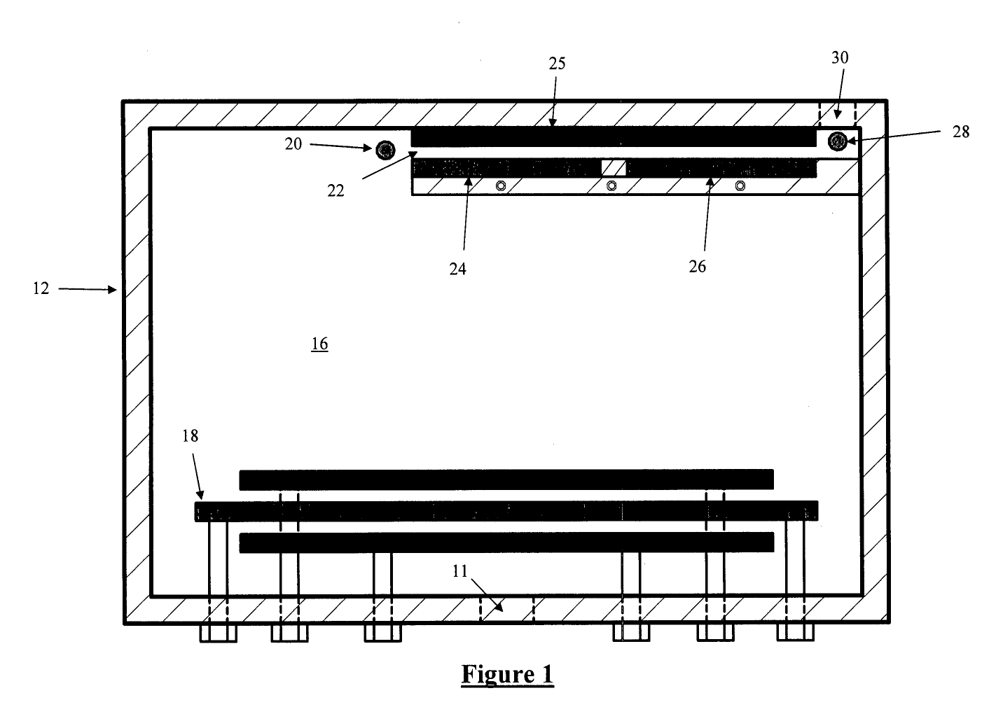

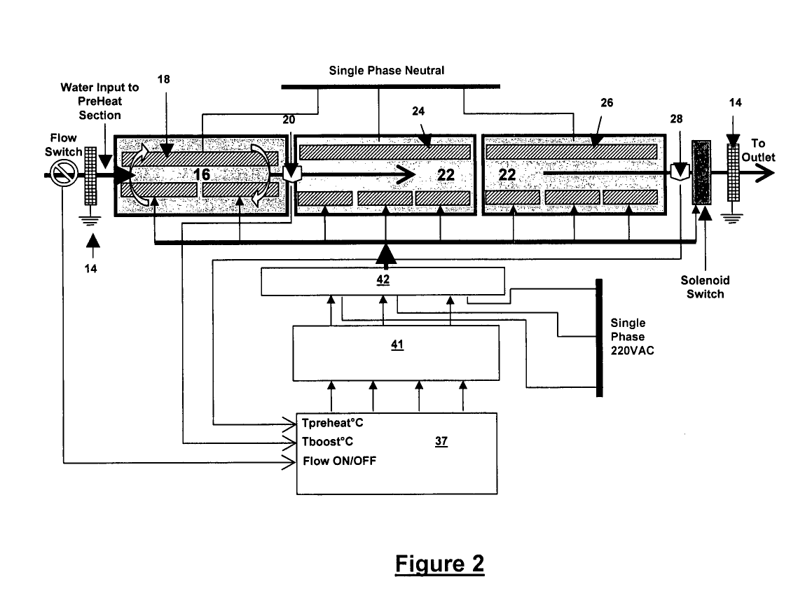

Referring to the drawings, FIG. 1 is a side view of a fluid heating apparatus 10 of a heating system of one embodiment in which water is caused to flow through a body 12 from inlet 11 to outlet 30. The body 12 is preferably made from a material that is electrically non-conductive, such as synthetic plastic material. However, the body 12 is likely to be connected to metallic water pipe, such as copper pipe, that is electrically conductive. Accordingly, earth mesh grids 14 shown in FIG. 2 are included at the inlet 11 and outlet 30 of the body 12 so as to electrically earth any metal tubing connected to the apparatus 10. The earth grids 14 would ideally be connected to an electrical earth of the electrical installation in which the heating system of the embodiment was installed. As the earth straps 14 may draw current from an electrode through water passing through the apparatus 10, activation of an earth leakage circuit breaker or residual current device (RCD) may be effected. In a particularly preferred form of this embodiment, the system includes earth leakage circuit protective devices.

The body 12 defines a reservoir 16, which in this embodiment has a volume of 1.5 litres. Within the reservoir 16 is provided a set of preheat electrodes 18. The electrodes are mounted in the horizontal plane to maximise convection efficiency. The electrode material may be any suitable metal or a non-metallic conductive material such as conductive plastics material, carbon impregnated material or the like. It is important that the electrodes are selected of a material to minimise chemical reaction and/or electrolysis.

During a Preheat Step, the water in the preheat reservoir 16 is preheated by electrodes 18 to a preheat temperature greater than the ambient temperature of water entering the reservoir 16, but less than a desired output temperature of water output by the apparatus 10. In the present embodiment the preheat temperature is 60° C. and is measured at the inlet to the outflow temperature boost passage 22 by a temperature probe 20. Water in the reservoir 16 heated to the preheat temperature is then ready for on-demand use.

When an outlet tap (not shown) is opened, water flows from reservoir 16 through the outflow temperature boost passage 22, during a boost stage. Outflow temperature boost passage comprises electrode sets 24 and 26 with a common ground or neutral electrode 25 which are controlled by a power supply controller 41 so as to heat the water flowing through passage 22 to a temperature of 90° C. as measured by temperature probe 28 positioned at the outlet 30 of the passage 22.

The power supply controller 41 also receives signals directly from a flow measurement device (not shown) located in the passage 22 and a temperature setting device 37 by which a user can set a desired output fluid temperature, and additional signals from reservoir temperature measurement device 20 to measure the temperature of input fluid to the passage 22, output temperature measurement device 28 measuring the temperature of fluid exiting the passage 22. Controller 41 may be responsive to signals from intermediate temperature measurement device(s) (not shown) between electrode set 24 and electrode set 26, to measure fluid temperature between the electrodes 24 and 26.

The power controller 41 receives the various monitored inputs and performs necessary calculations with regard to desired electrode pair voltages to provide a calculated power to be supplied to the fluid present in reservoir 16 and/or flowing through the passage 22. The power controller 41 controls the pulsed supply of voltage from each of the three separate phases connected to each of the electrode pairs 18, 24 and 26. Each pulsed voltage supply is separately controlled by the separate control signals from the power controller 41 to a power switching device module 42.

It will therefore be seen that, based upon the various parameters for which the power controller 41 receives representative input signals, a computing means under the control of a software program within the power controller 41 calculates the control signals required by the power switching device module 42 in order to supply a required electrical power to impart the required temperature change in the water present in the preheat reservoir 16 and/or flowing through the passage 22 so that heated water is emitted from the passage 22 at the desired temperature set by the temperature device 37.

When a user sets the desired output water temperature using the set temperature device 37, the set value is captured by the power controller 41 and stored in a system memory until it is changed or reset. Preferably, a predetermined default value of 90 degrees Celsius is retained in the memory, and the set temperature device 37 may provide a visual indication of the temperature set. The power controller 41 may have a preset maximum for the set temperature device 37 which represents the maximum temperature value above which water may not be heated. Thus, the value of the set temperature device 37 cannot be greater than the maximum set value. The system may be designed so that, if for any reason, the temperature sensed by the output temperature device 36 was greater than the set maximum temperature, the system would be immediately shut down and deactivated.

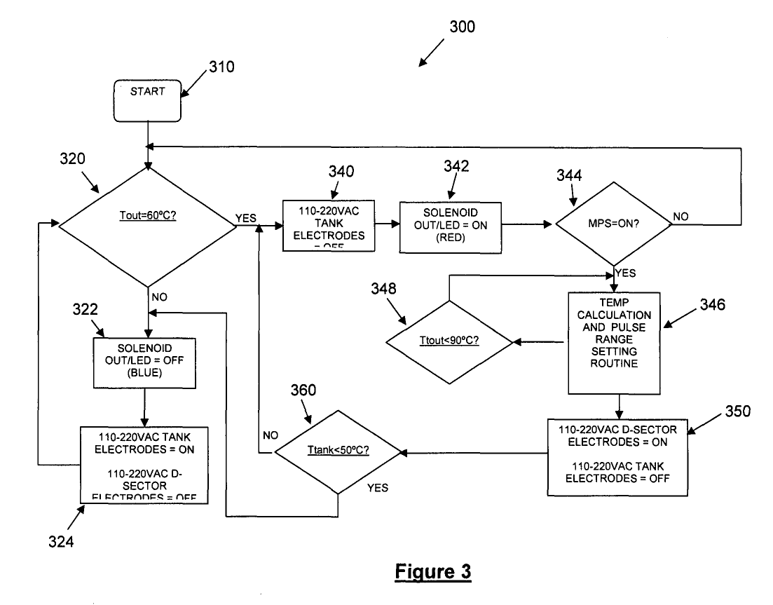

FIG. 3 is a flowchart 300 illustrating the two stages of operation of the apparatus 10. In the preheat stage of operation, temperature probe 20 is used to determine whether the water temperature in reservoir 16 is at the preheat temperature of 60 degrees, at 320. If not, a visible output indicator LED is turned off (blue) at 322, and the electrodes 18 of the reservoir 16 are actuated at 324 to heat the water until the temperature rises to 60 degrees, with the process returning to 320.

Once the reservoir water temperature is at 60 degrees, the process moves to a boost stage, in which the reservoir electrodes 18 are switched off at 340, the output LED indicator is turned on (red) at 342, and the system watches at 344 for activation of the MPS by a user opening an outlet tap. For so long as the outlet tap is closed the system returns to 320 so as to maintain the reservoir temperature. However if at step 344 the outlet tap is open a required temperature gain calculation is performed at 346 in order to set a pulse range routine to be applied by electrodes 24 and 26 so as to heat fluid in the outflow passage 22 by an appropriate amount. If at 348 the output temperature as measured by probe 28 is less than the desired temperature (90 degrees in this instance), then the step 346 is repeated so as to revise the pulse routine. At 350 the electrodes 24 and 26 are kept on in the manner defined by step 346, and the tank electrodes 18 remain deactivated.

Process 300 then moves to decision point 360 where it is determined whether the temperature measured by probe 20 is less then 50 degrees Celsius (i.e. more than 10 degrees below the desired reservoir temperature of 60 degrees). If so, the process returns to the reservoir preheating stage at 322. If not, the process returns to the boost heating process at 340.

The boost system is actuated when water flow in passage 22 is detected. This causes initiation of the boost heating sequence. The temperature of reservoir water is measured by the input temperature device 20 and this value is captured by controller 41 and recorded in the system memory. With the set temperature device 37 having a set or default temperature value, the required change in water temperature is easily determined, being the difference between the set temperature and the measured input temperature. Notably, the temperature of the reservoir water at 20 is repeatedly measured and if the value changes, the calculated temperature difference also varies.

The computing means 41 is then able to determine the electrical power that needs to be applied to the water flowing through the passage 22 in order to increase its temperature from the measured input temperature at 20 to the set temperature. Having calculated the electrical power that needs to be applied to the flowing water, the computing means 41 is then able to calculate the voltage that needs to be applied between the pairs of electrodes 24 and 26 to thereby cause the required current to flow through the water.

In the present embodiment, as part of an initial heating sequence of water flowing through passage 22, the applied voltage is set to a predetermined low value in order to calculate the water conductivity, or specific heat capacity. The application of this voltage to the water will cause current to be drawn, and a current measuring device of controller 41 will measure the drawn current and provide a signal to the controller 41. The value of the total current is also measured periodically.

The control system 41 then performs a series of checks to ensure that:

(a) the water temperature at the outlet does not exceed the maximum allowable temperature;

(b) leakage of current to earth has not exceeded a predetermined set value; and

(c) system current does not exceed a preset current limit of the system.

These checks are repeatedly performed while the unit is operational and if any of the checks reveals a breach of the controlling limits, the system is immediately deactivated. When the initial system check is satisfactorily completed, a calculation is performed to determine the required voltage that must be applied to the water flowing through the passage 22 in order to change its temperature by the desired amount. The calculated voltage is then applied to the pairs of electrodes 24 and 26 so as to quickly increase the water temperature as it flows through the passage 22.

As the water flowing through the passage 22 increases in temperature from the inlet end of the passage, the conductivity changes in response to increased temperature. One or more intermediate temperature measuring devices and the output temperature measuring device 28 measure the incremental temperature increases in the two segments of the passage 22 containing the electrode sets 24 and 26, respectively. The voltage applied across the respective pairs of electrodes 24 and 26 can then be varied to take account of the changes in water conductivity to ensure that an even temperature rise occurs along the length of the passage 22, to maintain a substantially constant power input by each of the sets of electrodes 24 and 26 and to ensure greatest efficiency and stability in water heating between the input temperature measurement at 20 and the output temperature measurement at 28. The power supplied to the flowing water is changed by increasing or decreasing the number of control pulses supplied by power switching module 42. The serves to increase or decrease the power supplied by individual electrode pairs 24 and 26 to the water.

It is to be appreciated that in this embodiment the system repeatedly monitors the water in both the reservoir 16 and passage 22 for changes in conductivity by continuously interrogating the system current drawn by electrode pairs 18, 24 and 26 for a given voltage, and the temperature measured by probes 20 and 28, and by any temperature probes interposed between electrode sets 24 and 26. Any changes in the values for the water temperatures or changes in the detected currents cause the computing means to calculate revised average voltage values to be applied across the electrode pairs 18, 24 and 26. Constant closed loop monitoring of changes to the system current, individual electrode currents or electrode segment water temperature causes recalculating of the voltage to be applied to the individual electrode segments to enable the system to supply the appropriate stable power to the water in the reservoir 16 and/or flowing through the passage 22.

The teachings of U.S. Pat. No. 7,050,706, the content of which is incorporated herein by reference, may be applied to control operation of aspects of the present apparatus and system, such as the electrodes of the outflow temperature boost passage.

It will be appreciated that any number of sets of electrodes may be used in the performance of the present invention. Thus, while the embodiments described show three electrode sets, with one electrode set for preheating the reservoir water and two electrode sets for boost heating the outflow water flowing through passage 22, the number of electrodes in the reservoir and/or passage may be altered in accordance with individual requirements or application specifics for fluid heating. If the number of electrodes is increased to, for example, six pairs, each individual pair may be individually controlled with regards to electrode voltage in the same way as is described in relation to the embodiments herein.

It is to be appreciated that by utilising electrode pairs which cause current to flow through the water itself such that heat is generated from the resistivity of the fluid itself, the present invention obviates the need for electrical resistance elements, thus ameliorating the problems associated with element scaling or furring. Moreover, by heating the contents of the preheat reservoir 16 to a temperature of 60 degrees which is substantially less than the desired output temperature of 90 degrees, the present embodiment reduces the amount of heat loss between flow times and thus reduces energy consumption.

It is further to be appreciated that the invention can be applied in applications that include, but are not limited to, domestic hot water systems and domestic boiling water dispensers. In relation to both such applications, which are often used for household hot water requirements, the invention can facilitates both energy and water savings. Additionally the system principles allow for ease of manufacture, ease of installation at point of use, pleasing aesthetics, and accommodates market established comfort factors. In describing the modes of operation is such applications in more detail, we first consider hot water systems.

A hot water system in accordance with one embodiment of the invention provides a through flow, instantaneous on-demand hot water system that delivers hot water at pre-settable or fixed temperature to one or more of kitchen, bathroom and laundry in a domestic setting. The output temperature can be accurately controlled and kept stable despite adverse water supply conditions that may prevail. The electrical power requirements for this type of application usually range between 18 kW and 33 kW and most often will require a three phase electrical power source. Alternatively, a single phase electrical power source might be provided that can accommodate these power requirements. The power requirements can vary depending on the specific nature of the application. The system is designed to deliver hot water to the user at flow rates varying between 0.5 litres/min and 15 litres/min. Again this depends on the specific application. Output water temperatures can be fixed or made settable between 2 deg C. and 60 deg C., which again depend on the application and domestic regulations. The temperature increment capability will nominally be 50 deg C. at 10 litres/min, but again depends on the application.

We now turn to the boiling water dispenser mode in which the present invention may be employed. The boiling water dispenser in one embodiment of the invention provides a through flow, instantaneous on-demand boiling water dispenser designed to deliver hot water at a fixed output temperature, up to a maximum of 95 deg C. This unit will most often be installed at the point of use in a kitchen-type environment. The output temperature is accurately controlled and kept stable despite adverse water supply conditions that may prevail. The electrical power requirements for this type of application usually range between 1.8 kW and 6 kW. The flow rate of this dispenser is fixed. This would nominally be fixed at a rate of either 1.0 litres/min or 1.2 litres/min, but again this depends on the application. The power requirement is dependent on the application requirements.

We now turn to a through flow boiling water dispenser in accordance with the present invention. If such a system is required to deliver boiling water instantaneously and continuously at 1.0 litres/min without storage, then 6 kW of electrical power is required and a commensurate electrical supply circuit needs to be installed. This embodiment is capable of delivering boiling water practically continuously without interruption for as long as is required. Previously, delivery of continuous boiling water could not be accommodated by available, competitive instantaneous hot water system technology due to the requirement for high line pressures that necessarily result in flow rates of greater than 3 litres/min. It is not practical to use flow rates much greater than 1.2 litres/min for boiling water dispensers.

In an embodiment in accordance with another mode of the present invention, a two stage boiling water dispenser is provided. If normal single phase power outlets are to be used, the power requirement can be kept to between 1.8 kW and 2.0 kW which is acceptable for standard domestic power points, and does not require additional or special power circuits. This embodiment requires a two stage boiling water dispenser system that includes a water storage component as well as a dynamic through flow component. In this regard, water is first heated to 70 deg C. in a storage system designed to hold nominally 1.8 1litres to 2.0 litres of water. Once heated to 70 deg C., the boiling water dispenser becomes operable, at which time when turned on the water at 70 deg C. is delivered through the dynamic section to the delivery outlet. This dynamic sector heats the water flowing at 1.0 litres/min to 1.2 liters/min on demand by an additional 25 deg C., to an output temperature of 95 deg C.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. An apparatus for heating fluid comprising:
a preheat reservoir having at least one pair of reservoir electrodes between which an electric current can be passed through fluid in the preheat reservoir, to heat fluid in the reservoir to a preheat temperature, the preheat temperature being less than a desired output fluid temperature of the apparatus; and
an outflow temperature boost passage through which fluid from the preheat reservoir flows to an outlet of the apparatus, the outflow temperature boost passage having at least one pair of outflow electrodes between which an electric current can be passed through fluid in the outflow temperature boost passage, to heat fluid dynamically in the outflow temperature boost passage to the desired output fluid temperature.

2-5. (canceled)

6. The apparatus of claim 1 wherein the outflow temperature boost passage comprises at least first and second electrode sets disposed along the outflow temperature boost passage, said first electrode set and said second electrode set each having at least one pair of electrodes between which an electric current is passed through the said fluid to heat the fluid during its passage along the outflow temperature boost passage.

7. The apparatus of claim 6 wherein the electrodes of each pair are spaced across the flow path so that voltage applied between the electrodes of each pair causes current to flow through the fluid across the flow path as the fluid passes along the outflow temperature boost passage.

8. (canceled)

9. The apparatus of claim 1 further comprising electrical control means to supply and control electrical power to the electrodes of the outflow temperature boost passage, said control means having processing means to initiate heating in response to sensed fluid flow and to relate current flow and applied voltage in response to measured reservoir fluid temperature and measured output fluid temperature and fluid flow rate, to determine desired power input to the fluid from each electrode set to achieve a desired output fluid temperature.

10. The apparatus of claim 9 further comprising an intra passage temperature measuring means for measuring the temperature of the fluid between the first and second electrode sets of the outflow temperature boost passage, wherein the control means controls power to the first and second electrode sets in accordance with the measured temperatures and a desired temperature increase of the fluid across each respective electrode set.

11. The apparatus of claim 1 further comprising a microcomputer controlled management system for controlling electrical power passed to the fluid.

12. The apparatus of claim 11 wherein the microcomputer controlled management system is operable to detect and accommodate changes in the specific conductance of the fluid itself due to the change in temperature of the fluid within the outflow temperature boost passage.

13. The apparatus of claim 11 wherein the microcomputer controlled management system is operable to detect and accommodate changes in electrical conductivity of incoming fluid.

14. The apparatus of claim 11 wherein the microcomputer controlled management system is operable to: apply a variable electrical voltage between the electrodes of each set to thereby pass electrical currents through the fluid between electrodes of each set; monitor the currents passing through the fluid between electrodes of each electrode set in response to application of the variable electrical voltage; and control the variable electrical voltage between electrodes of each electrode set in response to the specific conductance of the fluid as determined by reference to the monitored fluid temperatures and current flows such that an amount of electrical power passed to the fluid by each electrode pair corresponds to and effects a predetermined temperature increase of the fluid.

15. The apparatus of claim 11 wherein the microcomputer controlled management system is operable to compensate for a change in the electrical conductivity of the fluid caused by varying temperatures and varying concentrations of dissolved chemicals and salts, and through the heating of the fluid, by altering the variable electrical voltage to accommodate for changes in specific conductance when increasing the fluid temperature by the desired amount.

16. (canceled)

17. A method of heating fluid comprising:
passing an electric current between at least one pair of reservoir electrodes of a preheat reservoir through fluid in the preheat reservoir, to heat the fluid in the reservoir to a preheat temperature, the preheat temperature being less than a desired output fluid temperature; and
at times of fluid outflow through an outflow temperature boost passage, passing current between at least one pair of outflow electrodes through fluid in the outflow temperature boost passage, to heat fluid dynamically in the outflow temperature boost passage to the desired output fluid temperature.

18-19. (canceled)

20. The method of claim 17 wherein the outflow temperature boost passage comprises at least first and second electrode sets disposed along the outflow temperature boost passage, said first electrode set and said second electrode set each having at least one pair of electrodes, the method further comprising passing an electric current through the said fluid via each pair of electrodes to heat the fluid during its passage along the outflow temperature boost passage.

21. (canceled)

22. The method of claim 17 further comprising supplying and controlling electrical power to the electrodes of the outflow temperature boost passage by an electrical control means, said control means having processing means relating current flow and applied voltage in response to measured reservoir fluid temperature and measured output fluid temperature and fluid flow rate, and determining desired power input to the fluid from each electrode set to achieve a desired output fluid temperature.

23. The method of claim 22 further comprising measuring the temperature of the fluid between the first and second electrode sets of the outflow temperature boost passage, wherein the control means controls power to the first and second electrode sets in accordance with the measured temperatures and a desired temperature increase of the fluid across each respective electrode set.

24. The method of claim 17 further comprising controlling electrical power passed to the fluid by way of a microcomputer controlled management system.

25. The method of claim 24 wherein the microcomputer controlled management system detects and accommodates changes in the specific conductance of the fluid itself due to the change in temperature of the fluid within the outflow temperature boost passage.

26. The method of claim 24 wherein the microcomputer controlled management system detects and accommodates changes in electrical conductivity of incoming fluid.

27. The method of claim 24 wherein the microcomputer controlled management system: applies a variable electrical voltage between the electrodes of each set to thereby pass electrical currents through the fluid between electrodes of each set; monitors the currents passing through the fluid between electrodes of each electrode set in response to application of the variable electrical voltage; and controls the variable electrical voltage between electrodes of each electrode set in response to the specific conductance of the fluid as determined by reference to the monitored fluid temperatures and current flows such that an amount of electrical power passed to the fluid by each electrode pair corresponds to and effects a predetermined temperature increase of the fluid.

28. The method of claim 24 wherein the microcomputer controlled management system compensates for a change in the electrical conductivity of the fluid caused by varying temperatures and varying concentrations of dissolved chemicals and salts, and through the heating of the fluid, by altering the variable electrical voltage to accommodate for changes in specific conductance when increasing the fluid temperature by the desired amount.

29. The method of claim 17 further comprising a user adjusting the desired temperature of the outlet fluid.
